(19) United States
(12) Patent Application Publication
(10) Pub. No.: US 2015/0269342 A1
(43) Pub. Date: Sep. 24, 2015

(54) Medical Monitoring Systems

(71) Applicant: Lilliane S. Swagger, Rockford, IL (US)

(72) Inventor: Lilliane S. Swagger, Rockford, IL (US)

(21) Appl. No.: 14/658,168

(22) Filed: Mar. 14, 2015

Related U.S. Application Data
(60) Provisional application No. 61/954,773, filed on Mar. 18, 2014.

(51) Int. Cl. G06F 19/00; G06Q 50/24

(52) U.S. Cl. CPC G06F 19/3418; G06Q 50/24; G06F 19/322

(57) ABSTRACT

A medical recording, reporting and transmission system includes a headset or other user interface for contemporaneously recording doctor orders, patient vital signs, medications administered and other events that occur in a CODE BLUE event. A monitor system may record and report medical events, provide instant playback for clarification of doctor orders and may interface with a drug interaction database and patient database to warn of possible medication conflicts. Recorded events may be transmitted directly into patient records and may be further submitted to a documentation process. The system provides accurate memorialization of medical events while freeing up heath care professionals from scribe duties.

### CROSS-REFERENCE TO RELATED APPLICATIONS

This is a utility application based upon and claims the priority date of U.S. patent application 61/954,773 filed on Mar. 18, 2014. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### BACKGROUND OF THE INVENTION

### (1) Field of the Invention

The invention generally relates to medical monitoring systems. More particularly, the invention relates to means and methods of creating and using real time medical monitoring systems that include voice activation, event recording and other features.

### BRIEF SUMMARY OF THE INVENTION

The present invention overcomes shortfalls in the related art by presenting an unobvious and unique combination and configuration of methods and components to provide health care professionals and patients under their care real-time, automated, voice activated, continuous recording, multi-feature monitoring and reporting systems.

In one disclosed embodiment, a disclosed monitor, sometimes called a Swagger Monitor comprises:

Remote access;

Contemporaneious and continuous voice activation, voice recording and voice instructions via a head set or other user interface;

Contemporaneous and continuous monitoring and recording of patient information such as patient blood pressure, temperature, oxygen saturation, heart rate, respiration rate, and medications taken;

Contemporaneous and continuous cross-referencing within an internal database or library of medications to avoid an overdose or the introduction of antagonistic medications or antagonistic procedures in light of past medications or known patient conditions; and

Hardware and software enabling voice recording and voice transcriptions, with the transcriptions entered into the medical records of the patient.

### DISCLOSED EMBODIMENTS

1. May be used during emergency events, such as “CODE BLUE” situations to enhance the quality and memorialization of oral information spoken by a doctor or other health care provider;

2. Increase the speed in which oral orders are issued;

2. Ensure that all information is absolutely accurately recorded and understood;

3. Record the time of events contemporaneously as events arise;

4. Print, record or otherwise enter information into patient files or other databases; and

5. Use for reference or clarification via audio playback as questions arise.

Disclosed monitors and headsets may be used as standalone systems to record audio input during emergency response events, record time of events and print out data. Disclosed embodiments may be used concurrently with existing devices and may not be intended to be used with other audio recording devices.

There are many shortfalls in the prior art as the medical community has used the same methods for documenting emergency situations over many years. A “CODE BLUE” is an emergency situation wherein medical care is provided as fast as circumstances permit. The application of medical care requires that all events, conditions, orders, treatments and other data is recorded. Unfortunately, health care providers are in short supply and thus the recording of such data often reduces the care applied to a patient as a health care worker manually records events.

In the prior art, in CODE BLUE events, a registered nurse is required to physically become a scribe or transcriptionist, writing notes to document doctor orders, directives and medication protocol. A problem in the prior art is that the registered nurse or other appointed health care scribe is also required to monitor vital signs in a crowded, noisy, chaotic and face paced environment.

Even under ideal prior art conditions, wherein a health care professional may be designated or assigned to scribe duty only, writing out or even typing out events is prone to transcription errors, hearing errors and other inaccuracies. In many real world prior art conditions, a health care provider is assigned scribe duty, but then provides medical assistance as emergency conditions dictate. After the emergency is concluded, the scribe then attempts to recollect events and then records events after the fact. Thus, there is amply room in the art for the improvements found in the disclosed embodiments.

These and other objects and advantages will be made apparent when considering the following detailed specification when taken in conjunction with the drawings.

### BRIEF DESCRIPTION OF THE DRAWINGS

FIG. 1 depicts a schematic view of a disclosed systems and methods

FIG. 2 depicts a user interface, such as a headset and receiver

FIG. 3 depicts a flow chart of system attributes or system sequences

FIG. 4 depicts a schematic view of a database and computer system

### REFERENCE NUMERALS IN THE DRAWINGS

100 a disclosed system in general
200 a screen or other user interface
210 a keyboard or other user interface
220 a power supply system, comprising a battery system and an electrical input system
230 a frame
240 a mobility system
250 a headset
251 a headset transmitter
252 a speaker of a headset 250
253 a microphone of a headset 250
300 patient interfaces or monitor systems
310 blood pressure cuff
320 temperature sensing systems
330 oxygen sensor
400 receiver equipped to receive voice signals from the headset 250
500 communication system
600 medical professional
700 a disclosed system or method of operation
710 vital signs are displayed upon a screen in real time
720 vital signs are saved
725 patient information is sent to a computer or database
730 documentation process
740 a headset or other input interface is worn and used
745 time and content of health care worker orders are saved to a database
750 oral input and time of input are blended
755 audio playback of prior orders is available
760 audio information sent to hard copy and/or documentation process 730
800 a plurality of databases
810 database of patient records
815 database of drug interactions
820 database of events
825 database of documentation
830 non-transitory machine readable media having machine readable instructions
835 non-volatile memory in communication with the machine readable media and the processor 840
840 general or specialized processor in communication with the non-volatile memory 835 and the plurality of databases 800

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines

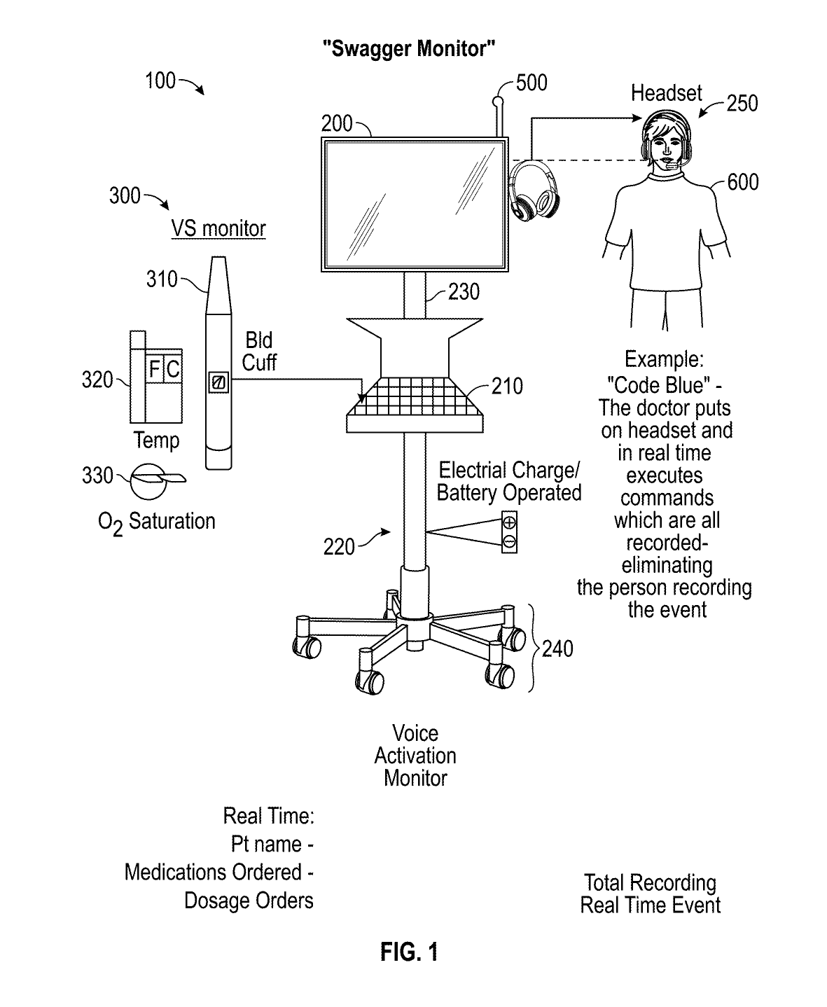

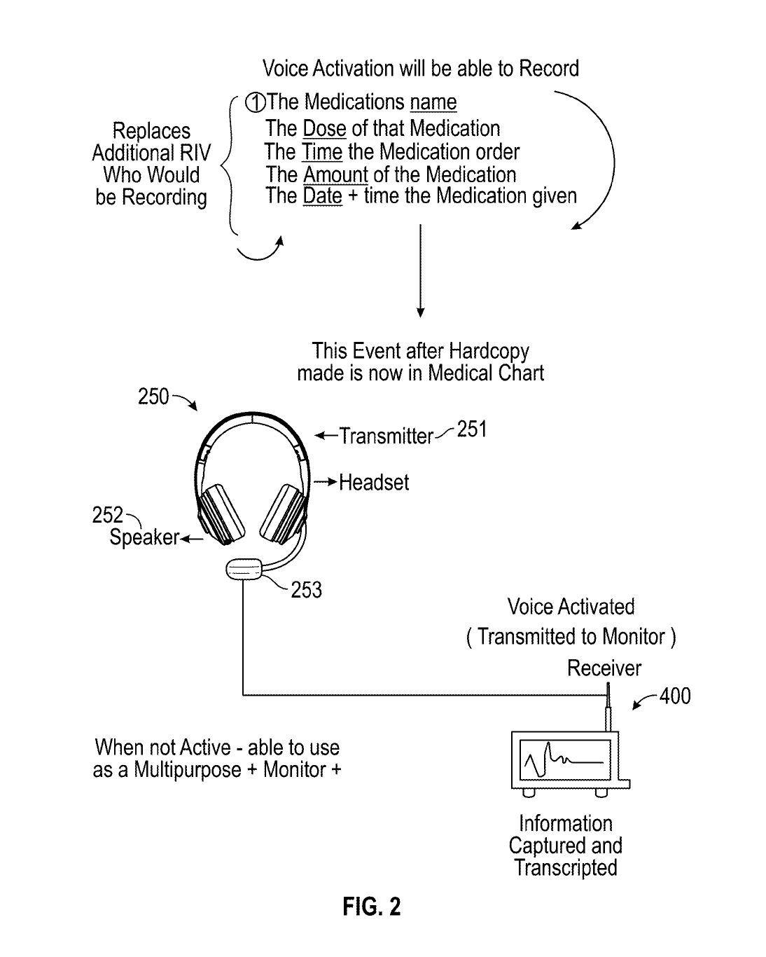

FIG. 1 depicts a disclosed system 100 comprising a frame 230 or cart having a mobility system 240 or wheels with the cart further comprising a screen 200, keyboard 210 and a communication system 500. The communication system may include or be in communication with a receiver 400, such as the receiver shown in FIG. 2.

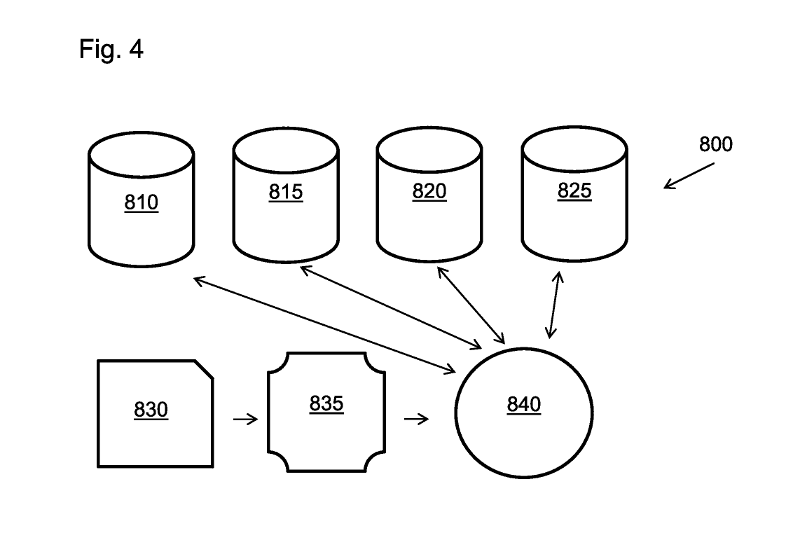

A headset 250 may be used by a medical professional 400 to send voice signals or voice commands with are recorded, transcribed and contemporaneously entered into a patient's medical records. Medical records may be in hard copy or paper from and/or may be stored within a database, such as a database system shown in FIG. 4.

Referring back to FIG. 1, patient monitoring systems 300 may include instruments such as a blood pressure cuff 310, temperature sensing system 320 and an oxygen saturation monitor 330. Other patient monitoring systems or instruments are contemplated herein.

FIG. 2 depicts a headset 250 comprising a transmitter 251, speaker system 252. FIG. 2 also depicts a receiver 400 having means to accept voice signals or other information from the headset 250 and or monitor system 100.

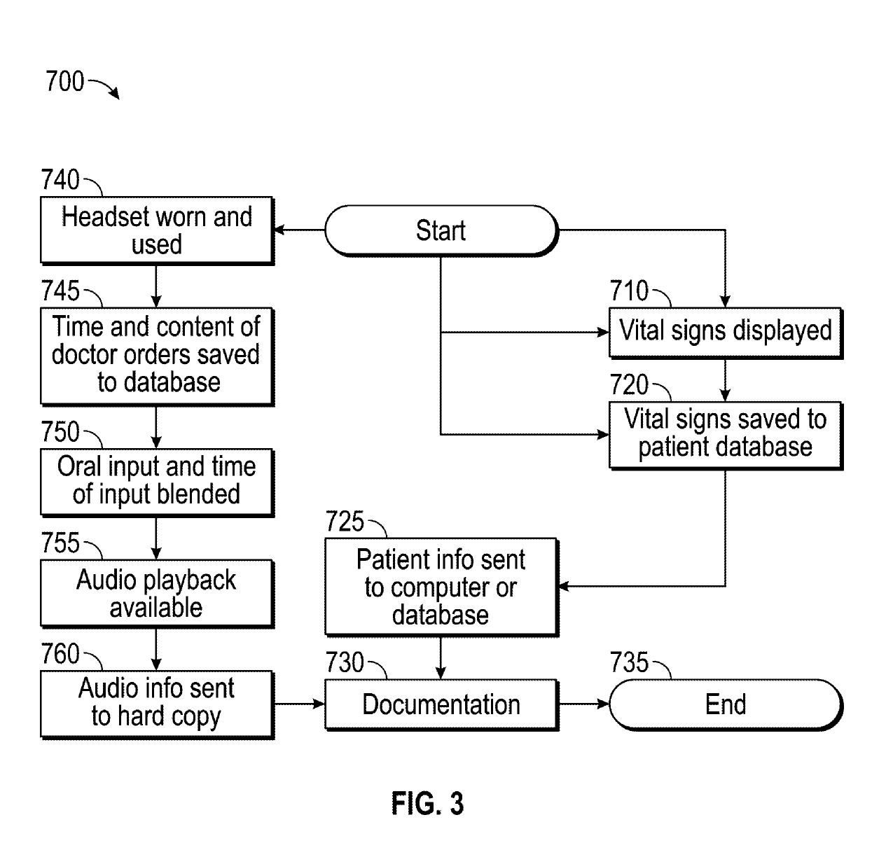

FIG. 3 depicts a flow chart 700 showing a system and process wherein from a starting state vital signs are displayed 710 and vital signs are saved to a patient database 720. Patient information is sent to a computer or database 725 and then a documentation process 730. On the health care provider side, a headset or other user interface is worn and used 740. The use of the headset may include the audio capture of doctor orders or other verbal information issued by a health care provider. In a next step, 745, the exact time of a doctor's oral orders are stored within a database or other system component. In a next step, 750, the oral input is blended with the time of input. In a next step, 755, audio playback is available. Sometimes, in code blue circumstances, a health care provider may need clarification of a prior order or vital sign. The disclosed embodiments provide such on the fly clarifications. In a next step, 760 audio information is sent or converted into a hard copy and also sent to the documentation process 730.

FIG. 4 depicts a plurality of databases 800 which may comprise a database of patient records 810, a database of drug interactions 815, a database of events 820 and a database of documentation. Non-transitory machine readable media 830 may contain machine readable instructions to carry out the functions of the disclosed embodiments and/or to enable the disclosed databases. The machine readable instructions may be transferred to the non-volatile memory 835. A general or specialized processor 840 may be in communication with the non-volatile memory 835 and the plurality of databases 800.

Disclosed systems include hardware, software and databases to accept, transcribe and record names of medications, dosages of medications, times and dates of administering medications and other relevant events.

Disclosed systems may replace a nurse or other healthcare professional who is typically burdened with recording events and/or reporting past events. Disclosed systems may provide screen readouts of past events or hardcopy printouts, vitiating the need for healthcare professionals to locate and report past medical events. The documentation system or database may include vital signs and medications with contemporaneous time stamps.

Disclosed systems may be especially useful during an emergency situation or “code blue” call where the quick retrieval of patient information is critical. Heath care providers may review the screen 200 or receive a machine generated audio report of past medications, known allegories, past conditions and relevant information. During a code blue call, the system may contemporaneous record and transcribe actions taken, so as to efficiently record information and to allow more healthcare providers to provide health care and not secretarial services.

Disclosed systems 100 may include microphones attached to a system frame. The microphones may record and transcribe events without the use of the headset. Disclosed systems may include libraries or databases of medications, procedures, medical nomenclature and other useful information in the medical field.

Disclosed embodiments overcome shortfalls in the art by reducing human error and by making current medical records quickly available to health care providers. Disclosed embodiments include microchips akin to those of mobile phones, with the microchips or other hardware components recording and transmitting voice input and sensor input.

Disclosed embodiments overcome shortfalls in the art by providing convenient and efficient means of contemporaneously recording and time stamping doctor orders, vital signs, medications administered, actions taken and other data.

Disclosed embodiments may include the following items:

1. A patient monitoring system for contemporaneously recording voice commands, patient vital signs and for entering data into a patient database, the system comprising:

a headset in communication with a receiver, the headset comprising a headset speaker, headset microphone, and headset transmitter;

the receiver in communication with a monitor and keyboard, the receiver, monitor and keyboard connected to a frame and power supply;

a blood pressure cuff, temperature sensing system and oxygen sensor in communication with the receiver;

the receiver connected to a communication system and the communication system connected to a plurality of databases and a computer system, the plurality of databases comprising a database of patient records and a database of documentation; the computer system comprising a processor, the processor in communication with non-volatile memory and the non-volatile memory in communication with machine readable media with the machine readable media containing machine readable instructions.

2. The system of 1 wherein the plurality of databases includes a database of events and a database of drug interactions and wherein verbal commands received by the headset microphone are transmitted to the computer system and cross-referenced against data contained within the drug interaction database and wherein the verbal commands are entered into the database of events.

3. The system of 2 wherein verbal commands are blended with a time stamp with the blended verbal commands stored in the database of documentation.

4. The system of 3 wherein the verbal commands received by the headset microphone are transmitted to the patient record database and cross-checked with allergies and drug interactions rerecorded within the patient record database.

5. A method of recording information and cross-checking information with a drug interaction database and a patient record database, the method comprising the steps of:

using a headset to capture and transmit verbal commands, the headset comprising a headset speaker, headset microphone, and headset transmitter;

using a receiver to accept the verbal commands and to transcribe the verbal commands and to transmit the verbal commands to a computer system;

blending a time stamp to each verbal command and storing each blended verbal command in a documentation database;

using the computer system to search for drug interactions and patient allergies and patient conditions by cross referencing the verbal commands to data stored in a plurality of databases attached to the computer system, the plurality of databases comprising a patient record database, an event database, and documentation database; and

using a processor in communication with non-volatile memory and using machine readable instructions stored upon machine readable media.

What is claimed is:

1. A patient monitoring system for contemporaneously recording voice commands, patient vital signs and for entering data into a patient database, the system comprising:
a headset in communication with a receiver, the headset comprising a headset speaker, headset microphone, and headset transmitter;
the receiver in communication with a monitor and keyboard, the receiver, monitor and keyboard connected to a frame and power supply;
a blood pressure cuff, temperature sensing system and oxygen sensor in communication with the receiver;
the receiver connected to a communication system and the communication system connected to a plurality of databases and a computer system, the plurality of databases comprising a database of patient records and a database of documentation;
the computer system comprising a processor, the processor in communication with non-volatile memory and the non-volatile memory in communication with machine readable media with the machine readable media containing machine readable instructions.

2. The system of claim 1 wherein the plurality of databases includes a database of events and a database of drug interactions and wherein verbal commands received by the headset microphone are transmitted to the computer system and cross-referenced against data contained within the drug interaction database and wherein the verbal commands are entered into the database of events.

3. The system of claim 2 wherein verbal commands are blended with a time stamp with the blended verbal commands stored in the database of documentation.

4. The system of claim 3 wherein the verbal commands received by the headset microphone are transmitted to the patient record database and cross-checked with allergies and drug interactions rerecorded within the patient record database.

5. A method of recording information and cross-checking information with a drug interaction database and a patient record database, the method comprising the steps of:
using a headset to capture and transmit verbal commands, the headset comprising a headset speaker, headset microphone, and headset transmitter;
using a receiver to accept the verbal commands and to transcribe the verbal commands and to transmit the verbal commands to a computer system;
blending a time stamp to each verbal command and storing each blended verbal command in a documentation database;
using the computer system to search for drug interactions and patient allergies and patient conditions by cross referencing the verbal commands to data stored in a plurality of databases attached to the computer system, the plurality of databases comprising a patient record database, an event database, and documentation database;
using a processor in communication with non-volatile memory and using machine readable instructions stored upon machine readable media.
